(19) United States
(12) Patent Application Publication
(10) Pub. No.: US 2005/0185039 A1
(43) Pub. Date: Aug. 25, 2005

(54) Borderless inkjet printing, using continuous airstream to collect ink drops released slightly beyond edges of print medium

(75) Inventor: Gregory J. Garbacz, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/785,678

(22) Filed: Feb. 24, 2004

(51) Int. Cl. B41J 2/015

(52) U.S. Cl. 347/101

(57) ABSTRACT

A borderless inkjet printer includes a printhead movable to release ink drops on a print medium, and to release ink drops slightly beyond edges of the print medium in order to ensure edge-to-edge printing on the print medium. A air flow generator generates a constant airstream with direction and force so that ink drops released slightly beyond edges of the print medium are carried away by the constant airstream to prevent the drops from clinging to any edge of the print medium or even migrating to an underside of the print medium. A sump collects inkdrops carried by the constant airstream, to permit them to be reused for printing.

### FIELD OF THE INVENTION

The invention generally relates to borderless inkjet printing. More particularly, the invention relates to a continuous inkjet printer in which ink drops are released slightly beyond edges of a print medium in order to ensure borderless (edge-to-edge) printing.

### BACKGROUND OF THE INVENTION

Typically, in a continuous inkjet printer, a pressurized printing ink is formed into continuous inkjet filaments that project from closely spaced ink discharge nozzles on a printhead. Filament stimulation sources such as ink heaters or piezoelectric transducers operate as ink droplet generators, each time they are activated, by causing filament end-lengths to be broken off to form discrete ink drops. The ink drops are created for every possible pixel location on the print medium since it cannot be known beforehand when and where colored or black pixels will require an ink drop to be deposited on the print medium and when and where white pixels will not require an ink drop to be deposited on the print medium. The many drops not needed because of the white pixels are discarded in some fashion. Often, the discarded drops are electrostatically or otherwise deflected from the continuous stream of ink drops emerging from a nozzle and they are deposited in a gutter. The so-called “gutter drops” are returned to the pressurized ink source in order to be reused as possible “print” drops.

Historically, image prints were made with a blank border surrounding the printed image. However, today, borderless (edge-to-edge) prints are at least equally in demand. When a continuous inkjet printer is operated in a borderless print mode, it is difficult to cause the printhead to begin to release ink drops exactly at one edge of the print medium and to cease to release ink drops exactly at an opposite edge of the print medium. Instead, the printhead begins to release ink drops shortly before it is aligned with one edge of the print medium, and it continues to release ink drops slightly beyond an opposite edge of the print medium. This is referred to as ink “overspraying” or “overshooting” relative to edges of the print medium, and ensures edge-to-edge printing.

When ink drops are oversprayed relative to edges of the print medium, the drops can also deposit on the edges. A known problem in this instance is that ink drops can cling to edges of the print medium and even migrate to the underside of the print medium. This results in an unsightly print. Moreover, ink drops falling off edges of the print medium can contaminate components in the printer. Prior art attempts to prevent this problem are disclosed in U.S. Pat. No. 6,168,259 B1 issued Jan. 2, 2001 and U.S. Pat. No. 6,239,817 B1 issued May 29, 2001. In the patents, the printhead begins to release ink drops a predetermined distance, such as 2 mm, before the print head is aligned with one edge of the print medium, and it continues to release ink drops the same distance beyond an opposite edge of the print medium. The oversprayed ink is collected by an ink absorbent material adjacent edges of the print medium. In U.S. Pat. No. 6,168,259 B1, the ink absorbent material is located in open drain bins facing the print head. The drain bins are in communication with suction pumps which suction the collected ink from the drain bins, enabling the ink to gravity flow to a sump.

### SUMMARY OF THE INVENTION

According to one aspect of the invention there is provided a borderless inkjet printer, comprising:
a printhead movable to release ink drops on a print medium, and to release ink drops slightly beyond edges of the print medium in order to ensure edge-to-edge printing on the print medium; and
a air flow generator that generates a constant airstream with direction and force so that ink drops released slightly beyond edges of the print medium are carried away by the constant airstream to prevent the drops from clinging to any edge of the print medium or even migrating to an underside of the print medium.

According to another aspect of the invention there is provided a borderless inkjet printing method, comprising:
moving a printhead to release ink drops on a print medium, and to overspray ink drops relative to edges of the print medium in order to ensure edge-to-edge printing on the print medium; and
generating a constant airstream with direction and force adjacent edges of the print medium so that ink drops oversprayed relative to edges of the print medium are prevented by the constant airstream from clinging to any edge of the print medium or even migrating to an underside of the print medium.

### BRIEF DESCRIPTION OF THE DRAWINGS

FIG. 1 is a front elevation view, partly in section, of a borderless inkjet printer that is a preferred embodiment of the invention;

FIG. 2 is a top plan view, partly in section, of the borderless inkjet printer; and

FIG. 3 is a schematic block diagram of a control system in the borderless inkjet printer.

### DETAILED DESCRIPTION OF THE INVENTION

The invention is described as embodied in a continuous inkjet printer that can be operated in a borderless print mode. Since the features of such an inkjet printer are generally known, the detailed description which follows is directed in particular to those elements constituting parts of or cooperating directly with the invention. It is to be understood, however, that other elements not described may take various forms known to persons skilled in the printer art.

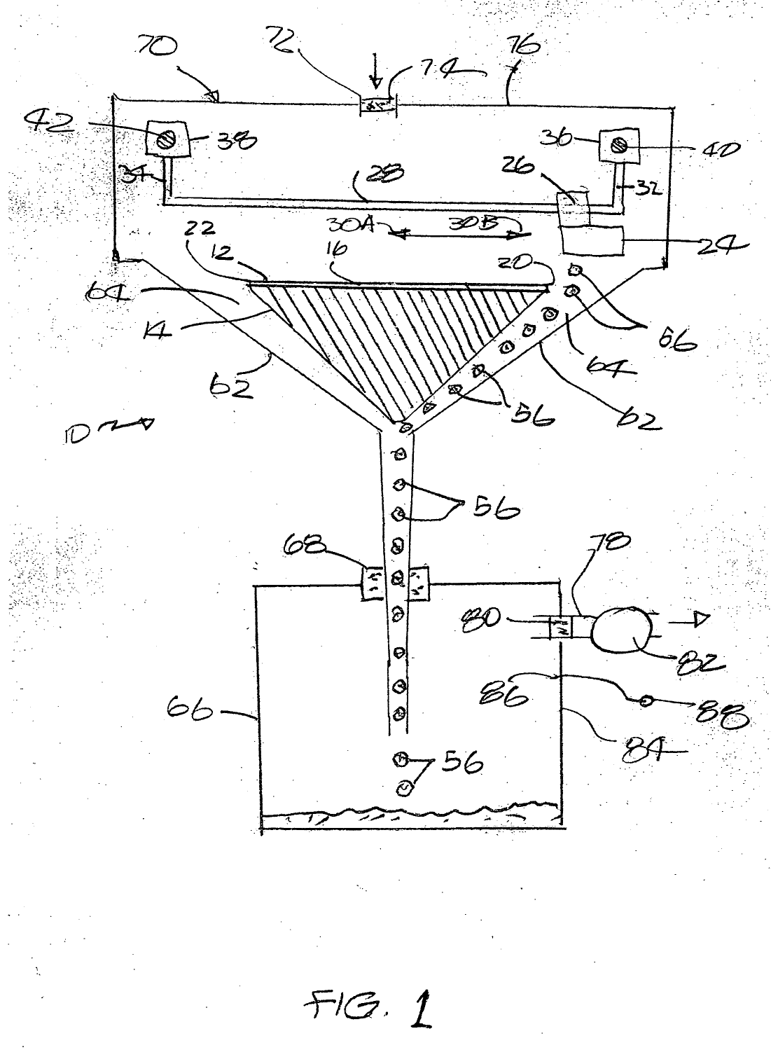

Referring now to the drawings, FIGS. 1-3 show a continuous inkjet printer 10 that is operable to make a borderless (edge-to-edge) print.

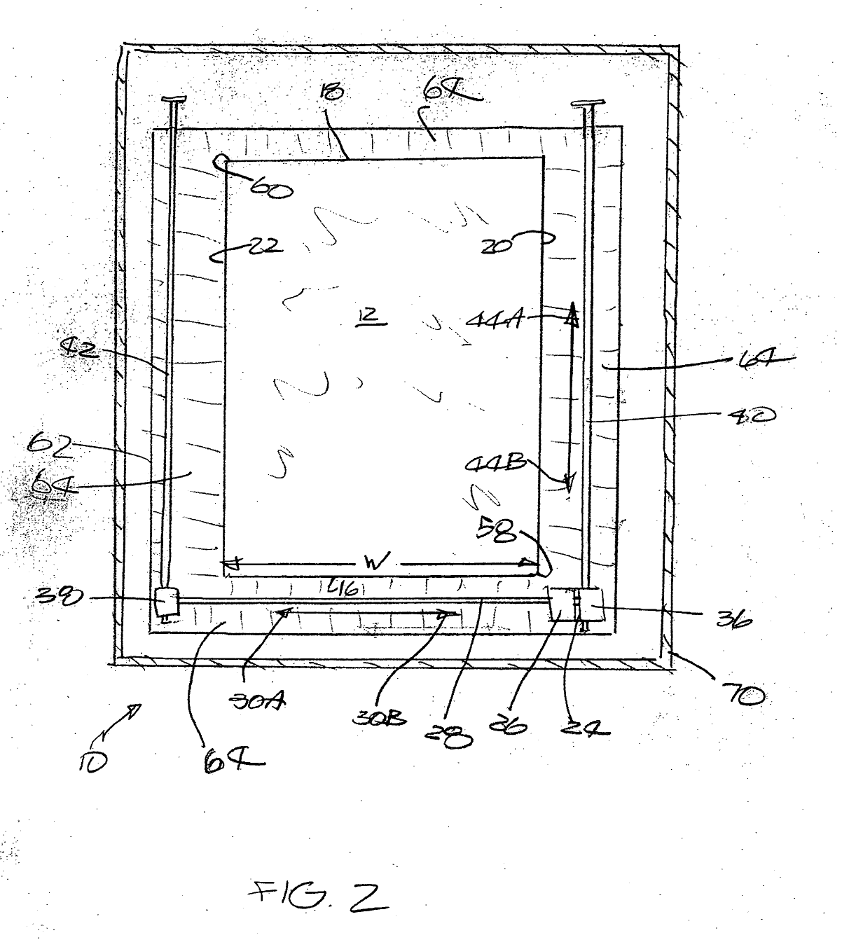

A print medium 12, e.g. a paper sheet, is supported flat on a medium support such as fixed platen 14. See FIG. 1. The print medium 12 has a front or leading edge 16, a rear or trailing edge 18, and a pair of opposite side edges 20 and 22. See FIG. 2.

A known type continuous inkjet printhead 24 is connected to a reversible motor 26 which in turn is movably mounted on a rod 28. When the motor 26 is energized, it is moved forward or backward along the rod 28 to translate the print head 24 in opposite x-x directions 30A and 30B above the print medium 12. The printhead 24 can begin to translate forward in the x-direction 30A in FIG. 1 before it is aligned with the side edge 20 of the print medium 12, and it is reversed to be translated backward in the x-direction 30B only after it is translated to beyond the side edge 22 of the print medium. When the printhead 24 is translated backward in the x-direction 30B, it always returns to being slightly beyond the side edge 20 of the print medium.

The rod 28 is suspended at respective ends by parallel equal-length suspension arms 32 and 34. See FIG. 1. The suspension arms 32 and 34 are connected to reversible motors 36 and 38 which in turn are movably mounted on parallel equal-length rods 40 and 42. When the motors 36 and 38 are simultaneously energized, they are moved forward or backward along the rods 40 and 42 to translate the print head 24 in opposite y-y directions 44A and 44B above the print medium 12. The printhead 24 can begin to translate forward in the y-direction 44A in FIG. 2 before it is aligned with the front edge 16 of the print medium 12 (but only when the printhead is returned in the x-direction 30B to being slightly beyond the side edge 20 of the print medium), and it is reversed to translate backward in the y-direction 44B only after it is translated to slightly beyond the rear edge 18 of the print medium (and the printhead is returned in the x-direction 30B to being slightly beyond the side edge 20 of the print medium). When the printhead 24 is translated backward in the y-direction 44B, it returns to being slightly beyond the front edge 16 of the print medium 12 as shown in FIG. 2. FIG. 2 shows a starting or initial position of the printhead 24.

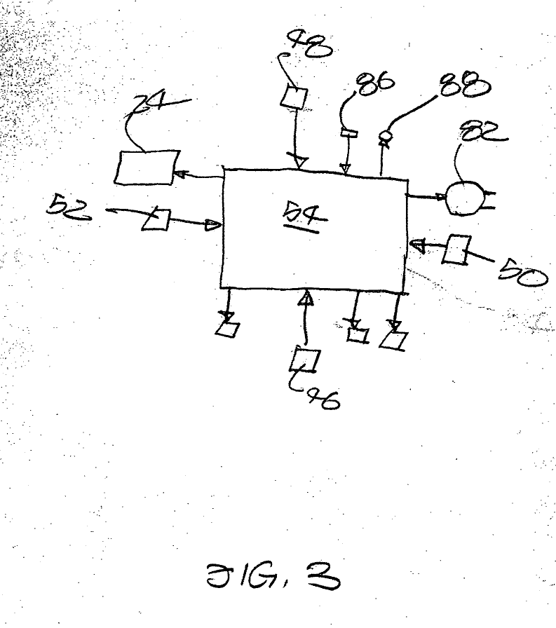

Respective edge sensors 46, 48, 50 and 52 on the printhead 24 sense when the printhead has moved beyond the front, rear, and side edges 16, 18, 22, and 24 of the print medium 12. The edge sensors 46, 48, 50 and 52 input sensing signals to a microprocessor control 54 which in turn controls individual energization of the motors 26, 38 and 38. See FIG. 3.

When the printhead 24 is translated forward and backward in the x-x-directions 30A and 30B, it releases a succession of ink drops 56 on the print medium 12 in order to make one line of a borderless print. See FIG. 1. The printhead 24 is translated forward in the y-direction 44A each time the printhead is returned to being slightly beyond the side edge 20 of the print medium 12. This allows the printhead 24 to print the next line of the borderless print. After the printhead 24 has been translated forward in the y-direction 44A to allow the printhead 24 to print the last (bottom) line of the borderless print, and is then translated forward and backward in the x-x directions 30A and 34, the printhead can be translated backward in the y-direction 44B to the starting position shown in FIG. 2. The ink drops 56 and not released when the printhead 24 is translated forward or backward in the y-directions 44A and 44B. Thus, the arrangement of the printhead 24, the edge sensors 46, 48, 50 and 52, the reversible motors 26, 36 and 38, and the rods 28, 40 and 42 allows the printhead to print one line at a time across the entire width W of the print medium 12, beginning at a corner 58 of the print medium formed by the front and side edges 16 and 20 of the print medium and ending at a corner 60 of the print medium formed by the rear and edges 18 and 22 of the print medium. See FIG. 2.

The printhead 24 actually begins to release the ink drops 56 shortly before it is aligned with the front and side edges 16 and 20 of the print medium 12, i.e. when it is initially translated forward in the x-direction 30A from the starting position shown in FIG. 2. The printhead 24 continues to release the ink drops 56 each time it is translated forward or backward in the x-x directions 30A and 30B from the side edges 20 and 22 of the print medium 12. Also, the printhead 24 releases the ink drops 56 when it is slightly beyond the side and rear edges 22 and 18 of the print medium 12, and is translated backward in the x-direction 30B to slightly beyond the side edge 20 of the print medium. This is referred to as ink “overspraying” or “overshooting” relative to the front, rear and side edges 16, 18, 20 and 22 of the print medium 12, and ensures edge-to-edge printing on the print medium.

When the ink drops 56 are oversprayed relative to the front, rear and side edges 16, 18, 20 and 22 of the print medium 12, the drops can also deposit on the edges. A known problem in this instance is that the ink drops 56 can cling to the edges of the print medium and even migrate to the underside of the print medium. This results in an unsightly print. Moreover, the ink drops falling off the edges of the print medium can contaminate components in the printer.

To solve this problem, there is generated a constant airstream with suitable direction and force that carries away the ink drops 56 that are oversprayed relative to the front, rear and side edges 16, 18, 20 and 22 of the print medium 12 so that the ink drops cannot cling to the edges of the print medium and migrate to the underside of the print medium. See FIG. 1. To this end, the platen 14 resides within a gravity drain basin 62 that is open facing the print head 12. A continuous space between the platen 14 and the gravity drain basin 62 defines a rectangular gutter 64 for receiving the oversprayed drops 56 that are carried away by the constant airstream. See FIGS. 1 and 2. The gutter 64 empties (drains) into a collection sump 66 which is coupled with the gravity drain basin 62 via an airtight seal 68.

A removable cover 70 is fitted onto the gravity drain basin 62 as shown in FIG. 1. The cover 70 and the gravity drain basin 62 collectively enclose the printhead 24, the reversible motors 26, 36 and 38, the rods 28, 40 and 42, and the platen 14.

An air intake port 72 including an air filter 74 is centered in a top portion 76 of the cover 70. An air exhaust port 78 including an air filter 80 and a pump 82 is located in a wall portion 84 of the collection sump 66. The air intake port 72 and the air exhaust port 78 including the pump 82 serve as an air flow generator for generating the constant airstream that carries away the ink drops 56 that are oversprayed relative to the front, rear and side edges 16, 18, 20 and 22 of the print medium 12. As can be appreciated from viewing FIG. 1, the constant airstream carries the oversprayed drops 56 into the gutter 64 and thence into the collection sump 66. The ink drops 56 accumulate in the bottom of the collection sump 66. When the ink volume accumulated in the collection sump 66 reaches a certain level, a level sensor 86 triggers a warning alarm 88 and inputs a “full” signal to the microprocessor control 54 which then temporarily discontinues operation of the printer 10. A timer may be employed to delay discontinuing operation of the printer until print-making on the print medium 12 is completed.

The invention has been described in detail with particular reference to a preferred embodiment thereof, but it will be understood that variations and modifications can be effected within the spirit and scope of the invention. For example, in addition to the air exhaust port 78 including the air filter 80 and the pump 82 located in the wall portion 84 of the collection sump 66, a second air exhaust port including an air filter and a pump can be located in another wall portion of the collection sump. This change creates a stronger, more forceful, constant airstream. In this instance, the cover 70 can be dispensed with.

While the medium support is depicted as the fixed platen 14, a movable belt is a known substitute. In this instance, there is no need for the printhead 24 to be translated forward and backward in the y-y directions 44A and 44B since the print medium 12 would be appropriately moved.

### PARTS LIST

10. borderless inkjet printer
12. print medium
14. medium support
16. front edge
18. rear edge
20. side edge
22. side edge
24. continuous inkjet printhead
26. motor
28. rod
30A. x-direction
30B. x-direction
32. suspension arm
34. suspension arm
36. motor
38. motor
40. rod
42. rod
44A. y-direction
44B. y-direction
46. edge sensor
48. edge sensor
50. edge sensor
52. edge sensor
54. microprocessor control
56. ink drops
58. corner
60. corner
W. width
62. gravity drain basin
64. gutter
66. collection sump
68. seal
70. cover
72. air intake port
74. filter
76. top portion
78. air exhaust port
80. filter
82. pump
84. wall portion
86. level sensor
88. warning alarm

1. A borderless inkjet printer, comprising:
a printhead movable to release ink drops on a print medium, and to release ink drops slightly beyond edges of the print medium in order to ensure edge-to-edge printing on the print medium; and
a air flow generator that generates a constant airstream with direction and force so that ink drops released slightly beyond edges of the print medium are carried away by the constant airstream to prevent the drops from clinging to any edge of the print medium.

2. A borderless inkjet printer as recited in claim 1, wherein a medium support supports the print medium within the constant airstream in order that edges of the print medium are subjected to the constant airstream.

3. A borderless inkjet printer as recited in claim 2, wherein a sump is positioned relative to said medium support to collect ink drops that are carried by the constant airstream away from edges of the print medium.

4. A borderless print as recited in claim 2, wherein a gutter surrounds said medium support, including surrounding edges of the print medium, to collect ink drops that are carried by the constant airstream.

5. A borderless inkjet printer as recited in claim 1, wherein said air flow generator includes an enclosure for said printhead and the print medium, and an air exhaust from said enclosure cooperates with an air intake into said enclosure to generate the constant airstream.

6. A borderless inkjet printer as recited in claim 5, wherein said enclosure includes a sump to collect ink drops that are carried by the constant airstream away from edges of the print medium.

7. A borderless inkjet printer as recited in claim 5, wherein a
platen for supporting the print medium is located within said enclosure.

8. A borderless inkjet printer, comprising:
a printhead movable to release ink drops on a print medium, and to overspray ink drops relative to edges of the print medium in order to ensure edge-to-edge printing on the print medium; and
a air flow generator that generates a constant airstream with direction and force adjacent edges of the print medium so that ink drops oversprayed relative to edges of the print medium are prevented by the constant airstream from clinging to any edge of the print medium or even migrating to an underside of the print medium.

9. A borderless inkjet printer as recited in claim 8, wherein a medium support supports the print medium in the constant airstream so that at least edges of the print medium are subjected to the constant airstream.

10. A borderless inkjet printer as recited in claim 9 wherein a gravity drain is open proximate said printhead to receive ink drops oversprayed relative to edges of the print medium, said medium support is located within said gravity drain, and said air flow generator exhausts air from said gravity drain to cause the constant airstream to flow from said printhead into said gravity drain.

11. A borderless inkjet printer as recited in claim 10, wherein a sump is in airtight communication with said gravity drain and is positioned below said gravity drain to receive ink drops from said gravity drain.

12. A borderless inkjet printer as recited in claim 10, wherein a continuous space exists between said medium support and said gravity drain defines a gutter that receives ink drops oversprayed relative to edges of the print medium.

13. A borderless inkjet printer, comprising:
an enclosure;
a printhead movable within said enclosure to release ink drops on a print medium within said enclosure, and to release ink drops slightly beyond edges of the print medium in order to ensure edge-to-edge printing on the print medium; and
a air flow generator that generates a constant air flow into and out of said enclosure to create a constant airstream within said enclosure that carries away ink drops released slightly beyond edges of the print medium to prevent the drops from clinging to any edge of the print medium.

14. A borderless inkjet printing method, comprising:
moving a printhead to release ink drops on a print medium, and to overspray ink drops relative to edges of the print medium in order to ensure edge-to-edge printing on the print medium; and
generating a constant airstream with direction and force adjacent edges of the print medium so that ink drops oversprayed relative to edges of the print medium are prevented by the constant airstream from clinging to any edge of the print medium.

15. A borderless inkjet printing method, comprising:
moving a printhead to release ink drops on a print medium, and to release ink drops slightly beyond edges of the print medium in order to ensure edge-to-edge printing on the print medium;
generating a constant airsteam with direction and force so that ink drops released slightly beyond edges of the print medium are carried away by the constant airstream to prevent the drops from clinging to any edge of the print medium; and
collecting ink drops carried by the constant airstream in order to reuse them.

16. A borderless inkjet printing method, comprising:
moving a printhead within an enclosure to release ink drops on a print medium within the enclosure, and to release ink drops slightly beyond edges of the print medium in order to ensure edge-to-edge printing on the print medium; and
generating a constant air flow into and out of the enclosure to create a constant airstream within the enclosure that carries away ink drops released slightly beyond edges of the print medium to prevent the drops from clinging to any edge of the print medium.
